(19) United States
(12) Patent Application Publication
(10) Pub. No.: US 2003/0191678 A1
(43) Pub. Date: Oct. 9, 2003

(54) Disruption handling for scheduling system

(76) Inventors: Ravindra K. Shetty, Bangalore (IN); Chandrashekar Padubidri, Bangalore (IN); Sreedharan V. Venkataraman, Thanjavur (IN); Madhava K. Vemuri, Bangalore (IN); Ashwin Kumar, Hiriadka (IN)

Correspondence Address: HONEYWELL INTERNATIONAL INC., 101 COLUMBIA ROAD, P O BOX 2245, MORRISTOWN, NJ, 07962-2245, US

(21) Appl. No.: 10/115,473

(22) Filed: Apr. 3, 2002

(51) Int. Cl. G06F 17/60

(52) U.S. Cl. 705/8

(57) ABSTRACT

A scheduling system reschedules based on the affect such rescheduling has on cascading costs. The costs for an airline set of schedules include factors such as the affect on passengers, the affect on profit and other factors. Cascading costs include the cost of further disruptions to schedules as a result of proposed solutions to a disruption. The further disruptions are referred to as cascading disruptions since they cascade from the original disruption or solutions to the disruption. Disruptions are entered into a computer program and ranked by a common denominator such as cost by simulating the effects of the disruptions on the actual servicing of the schedules. Disruptions are prioritized based on their impact on the system if left unattended. Each disruption is then considered individually based on their rank, with the cascaded cost of proposed solutions calculated.

### FIELD OF THE INVENTION

The present invention relates to scheduling systems, and in particular to disruption handling for scheduling systems.

### BACKGROUND OF THE INVENTION

Scheduling systems are used in many different situations. Manufacturing plants utilize scheduling systems to schedule manufacturing resources to make products. As an example in an airline system, airlines transport people and cargo to multiple destinations. A number of airports are typically involved and schedules are planned to represent the daily trips that need to be made between origins and destinations. Each schedule needs to be serviced by a certain type of aircraft. Some trips repeat every day, and others on selected days.

Airlines generally have a limited number of aircrat at its disposal. It is desirable to use the same aircraft for different schedules by rotating the aircraft among schedules. This is possible by determining patterns in the schedules that allow the use of the same aircraft for flights in different schedules. Once the pattern is known, specific aircraft are assigned to patterns. Assignment of the aircraft is known as tail assignment, similar to resource allocation in other shceduling systems.

After the tail assignment or resource allocation, the aircraft starts servicing schedules. Often the operations of airlines are subjected to disruptions, because of factors such as weather, airport restrictions, aircraft unavailability and a variety of other reasons. These disruptions can have a cascading effect, so that a disruption directly affecting one schedule results in another disruption affecting a different schedule. For examle, a flight delay may result in passengers missing connections; crews missing their next duties; non-availability of this aircraft for subsequent flights; and many other events affecting the ability to accomplish a flight at a desired time.

### SUMMARY OF THE INVENTION

A scheduling system reschedules based on the affect such rescheduling has on cascading costs. Cascading costs include the cost of further disruptions to schedules as a result of proposed solutions to a disruption. The further disruptions are referred to as cascading disruptions since they cascade from the original disruption or solutions to the disruption.

In one embodiment, disruptions in an airline scheduling system are entered into a computer program and ranked by a common denominator such as cost by simulating the effects of the disruptions on the actual servicing of the schedules. Disruptions are prioritized based on their impact on the system if left unattended. Each disruption is then considered individually based on their rank, with the cascaded cost of proposed solutions calculated. The least cost solution is scheduled, and the next highest ranking cost disruption is then processed, until all schedule disruptions are resolved. The program is initialized periodically for entry of disruptions affecting that period, such as daily.

In a further embodiment, colored Petri Nets are used to analyze the solutions and cascading cost.

### BRIEF DESCRIPTION OF THE DRAWINGS

FIG. 1 is a block diagram of an airline scheduling system having a disruption handler.

FIG. 2 is a block diagram showing functional modules of a disruption handling system.

FIG. 3 is a flow chart showing disruption handling.

FIG. 4 is a block diagram of a cost function manager.

FIG. 5 is a block diagram of a rule based editor for specifying rules to determine cascading effects of disruptions.

FIG. 6 is a high level flow diagram showing a process of scheduling aircraft and handling disruptions.

FIG. 7 is a model of disruption handling for passenger emergencies and dynamic aircraft snags.

FIG. 8 is a model of disruption handling for dynamic airport constraints and weather disruptions.

FIG. 9 is a timing diagram illustrating a disruption and the cascading affect of potential solutions for the disruption.

FIG. 10 is a timing diagram showing flights being rescheduled in response to a disruption.

FIGS. 11A, 11B and 11C are is a colored Petri Net diagram showing modeling of the solution method.

FIG. 12 is a data flow diagram showing rerouting to identify optional solutions in response to a disruption.

FIG. 13 is a workflow diagram showing pattern assignment for a set of schedules.

FIG. 14 is a workflow diagram showing assignment of tails to patterns generated in accordance with FIG. 6.

FIGS. 15A, 15B, 15C and 15D are a flow diagram of an airline management system incorporating scheduling and interruption handling.

### DETAILED DESCRIPTION OF THE INVENTION

In the following description and the drawings illustrate specific embodiments of the invention sufficiently to enable those skilled in the art to practice it. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. The scope of the invention encompasses the full ambit of the claims and all available equivalents. The following description is, therefore, not to be taken in a limited sense, and the scope of the present invention is defined by the appended claims.

The functions described herein are implemented in software in one embodiment, where the software comprises computer executable instructions stored on computer readable medium such as memory or other type of storage devices. The term “computer readable media” is also used to represent carrier waves on which the software is transmitted. Further, such functions correspond to modules, which are software, hardware, firmware of any combination thereof. Multiple functions are performed in one or more modules as desired, and the embodiments described are merely examples.

The following sections describe disruption handling the context of an airline scheduling system, however the solution can be generalized for application in many different domains. Disruptions cause changes to schedules, and the changes have an accompanying cost. The current invention considers cascading costs of proposed solutions to reschedule service in a cost effective manner. Other domains include but are not limited to manufacturing, battlefield, and the transportation domain, or other domains where resources need to be scheduled and interruptions handled.

The purpose of an Airline is to transport people and cargo to where they wanted to go in a safe, convenient and cost effective manner. To satisfy this requirement, an airline typically services a set of airports. The marketing team of the airline does a market survey and determines a set of schedules originating and terminating at the above-mentioned airports. These schedules are published through predetermined time intervals (say, every six months). Typically, the schedules represent the daily trips that need to be made between an origin and destination. Each schedule needs to be serviced by a certain type of aircraft. For example, Table 1 represents some schedules of an airline,

TABLE 1
Some schedules of a commercial airliner.

| | | | Flight | Departure | Arrival | Days of | Type of |
|---|---|---|---|---|---|---|---|
| Number | Origin | Destination | No. | Time | Time | Operation | Aircraft |
| 1 | Bangalore | Cochin | 9W | 6:30:00 | 7:50:00 | Daily | ATR 72-500 |
| | | | 3511 | AM | AM | | |
| 2 | Bangalore | Mangalore | 9W | 10:20:00 | 11:25:00 | Daily | ATR 72-500 |
| | | | 3513 | AM | AM | | |
| 3 | Bangalore | Goa | 9W | 1:40:00 PM | 3:10:00 | Daily | ATR 72-500 |
| | | | 3515 | | PM | | |
| 4 | Bangalore | Coimbatore | 9W | 5:50:00 PM | 6:45:00 | Daily | ATR 72-500 |
| | | | 3517 | | PM | | |
| 5 | Bangalore | Chennai | 9W | 8:50:00 PM | 9:50:00 | Daily | ATR 72-500 |
| | | | 3508 | | PM | | |
| 6 | Bangalore | Mumbai | 9W | 10:30:00 | 12:45:00 | Daily | ATR 72-500 |
| | | | 2412 | PM | AM | | |
| 7 | Bhavnagar | Mumbai | 9W | 8:50:00 | 10:05:00 | Daily | ATR 72-500 |
| | | | 3412 | AM | AM | | |
| 8 | Chandigarh | Delhi | 9W | 2:40:00 PM | 3:40:00 | Daily | ATR 72-500 |
| | | | 3304 | | PM | | |
| 9 | Chennai | Hyderabad | 9W | 6:30:00 | 8:05:00 | Daily | ATR 72-500 |
| | | | 3501 | AM | AM | | |
| 10 | Chennai | Bangalore | 9W | 7:15:00 PM | 8:15:00 | Daily | ATR 72-500 |
| | | | 3507 | | PM | | |
| 11 | Cochin | Bangalore | 9W | 8:20:00 | 9:40:00 | Daily | ATR 72-500 |
| | | | 3512 | AM | AM | | |
| 12 | Coimbatore | Bangalore | 9W | 7:15:00 PM | 8:10:00 | Daily | ATR 72-500 |
| | | | 3518 | | PM | | |
| 13 | Delhi | Jaipur | 9W | 5:55:00 | 6:55:00 | Daily | ATR 72-500 |
| | | | 3401 | AM | AM | | |
| 14 | Jaipur | Udaipur | 9W | 7:35:00 | 8:40:00 | Daily | ATR 72-500 |
| | | | 3401 | AM | AM | | |
| 15 | Delhi | Udaipur | 9W | 5:55:00 | 8:40:00 | Daily | ATR 72-500 |
| | | | 3401 | AM | AM | | |
| 16 | Delhi | Chandigarh | 9W | 12:10:00 | 1:10:00 | Daily | ATR 72-500 |
| | | | 3303 | PM | PM | | |
| 17 | Delhi | Indore | 9W | 4:50:00 PM | 6:50:00 | 1 2 3 4 5 7 | ATR 72-500 |
| | | | 3305 | | PM | | |
| 18 | Diu | Mumbai | 9W | 12:15:00 | 3:00:00 | 1 2 3 4 5 7 | ATR 72-500 |
| | | | 3404 | PM | PM | | |
| 19 | Diu | Porbandar | 9W | 12:15:00 | 1:00:00 | 1 2 3 4 5 7 | ATR 72-500 |
| | | | 3403 | PM | PM | | |

It can be observed from Table 1 that schedules having numbers 1 to 16 are repeated daily, whereas schedules 17 to 18 repeated on all days except Friday (assumed that the days of operation “1” corresponds to Sunday). Similarly, all the schedules require service by “ATR 72-500” type aircraft.

As an airline will have a limited number of aircraft (fleet) at its disposal, it will not be possible to allocate an aircraft specifically to cater for a schedule. Therefore, an airline would like to use the same aircraft for different schedules by rotating that aircraft among schedules. For example, an aircraft identified as A001 is assigned to service schedule flight number 9W3511. After finishing its journey by reaching Cochin at 7.50 a.m. it can be used for flight 9W3512 starting from Cochin at 8.20 a.m. reaching Bangalore at 9.40 a.m. Subsequently the same aircraft can be used to cater for flight 9W3513. Hence, aircraft A001 is rotated among flights 9W3511, 9W3512, and 9W3513. This rotation is referred to as a pattern for an aircraft. The patterns help optimize aircraft utilization.

Once a pattern is arrived, then a specific aircraft is assigned to that pattern. It is known as Tail Assignment (Resource Allocation). After the tail assignment, aircraft start servicing schedules. Often the operations of airline can be subjected to disruptions because of factors such as, weather, airport restrictions, aircraft unavailability and a variety of other reasons. These disruptions can have a cascading effect so that disruption at one location could result in another disruption at some other locations. For example an arrival flight delay could result in the passenger (on that flight) missing connections; crew missing their next duties; non-availability of this aircraft for subsequent flights. Various disruptions and the associated cascading effects are shown in Table 2

TABLE 2
List of Typical Disruptions
Primary Problem (on top of current Cascading Effect constraints)

| | |
|---|---|
| Airport restrictions | |
| Equipment restriction at an Airport | Arrival Flight Delay, Flight |
| | Cancellation |
| Runway problems in one ore more | Arrival Flight Delay, Flight |
| airports | Cancellation |
| Night Bans | Arrival Flight Delay, Flight |
| | Cancellation |
| Accidents/Acts of God | Arrival Flight Delay, Flight |
| | Cancellation |
| Political Disturbances | Arrival Flight Delay, Flight |
| | Cancellation |
| Employee Strike | Arrival Flight Delay, Flight |
| | Cancellation |
| Watch outs (?) | Arrival Flight Delay, Flight |
| | Cancellation |
| Weather | |
| Reduced Visibility | Arrival Flight Delay, Flight |
| | Cancellation |
| Weather problem at one or more | Arrival Flight Delay, Flight |
| airports | Cancellation |
| Maintenance Restrictions | |
| Maintenance Schedules | Possible Aircraft Snags, Aircraft |
| | Availability |
| Aircraft Problems | |
| Snag on Ground | Departing Flight Delay, Aircraft |
| | Availability |
| Equipment problem in an aircraft | Departing Flight Delay, Aircraft |
| (MEL) | Availability |
| Snag during Flight | Arrival Flight Delay, Flight |
| | Cancellation |
| Aircraft Availability | Flight Cancellation |
| Ground activity problem | |
| Minimum Ground Time Violation | Departing Flight Delay |
| Gate unavailability | Arrival/Departure Flight Delay |
| Catering problem, Cleaning problem, | Departing Flight Delay |
| Other ground activities) - delay | |
| Fuelling Delay | Departing Flight Delay |
| Baggage Loading | Departing Flight Delay |
| Airobridge unavailability | Arrival/Departing Flight Delay |
| Pax, Cargo related | |
| Passenger delay | Passenger Delay |
| Baggage missing | Baggage Delay |
| Overload of passenger | Passenger Delay |
| Overload of Cargo | Baggage Delay |
| Passenger Emergencies | Arrival Flight Delay |
| Under load of Passenger | Passenger Delay |
| Crew Related | |
| Crew Emergencies | Arrival/Departing Flight Delay, |
| | Crew Availability |
| Incoming crew delay | Arrival/Departing Flight Delay |
| Crew delay at the terminal | Departing Flight Delay |
| Minimum Crew Connection Time | Departing Flight Delay |
| Crew unavailability | Departing Flight Delay |
| Reduced Crew | Departing Flight Delay |
| Flight Related | |
| Flight Cancellation | Aircraft Availability |
| Arrival Flight Delay | Aircraft Availability, Passenger |
| | Delay, Crew Availability |
| Departing Flight Delay | Arrival Flight Delay |

These disruptions impact current schedules (operations), resulting in delays, and causing potentially huge financial and good will losses to airlines. The current invention provides a software framework to handle disruptions via pattern assignment, and recover operations.

The software framework consists of three parts, a data management system, an assignment system and a disruption handling system. The data management system manages data requirements for the solution. Using this system a user imports domain specific data and translate the same to application specific data. The data can also be preprocessed for use in the application. It also facilitates a user to dynamically change the data while solving for a solution.

The Assignment System arrives at the schedules based on the data provided from data management system and also the constraints. Resources are then allocated to the schedules. The primary modules of the assignment system are a pattern identifier that identifies optimum patterns from the given schedules. An assignment manager assigns the resources to patterns. The functions of the data management system and the assignment system are well known in the art.

The disruption handling system (DHS) aids a decision-maker (DM) in arriving at a decision for handling disruptions to the system. One of the critical aspects of disruption handling is to minimize the cascading effects of a solution. In the current approach, evaluation of a candidate solution is performed using simulation. For a disruption, all candidate solutions are evaluated in terms of a common denominator (cost). Colored Petri Nets are used in one embodiment to analyze the solution steps.

Another important aspect is to prioritize disruptions. Candidate solutions for multiple disruptions compete for a set of fixed resources. Adopting a solution for one low priority disruption may preempt the solution for a high priority disruption. Disruptions are prioritized based on their impact on the system, if left unattended.

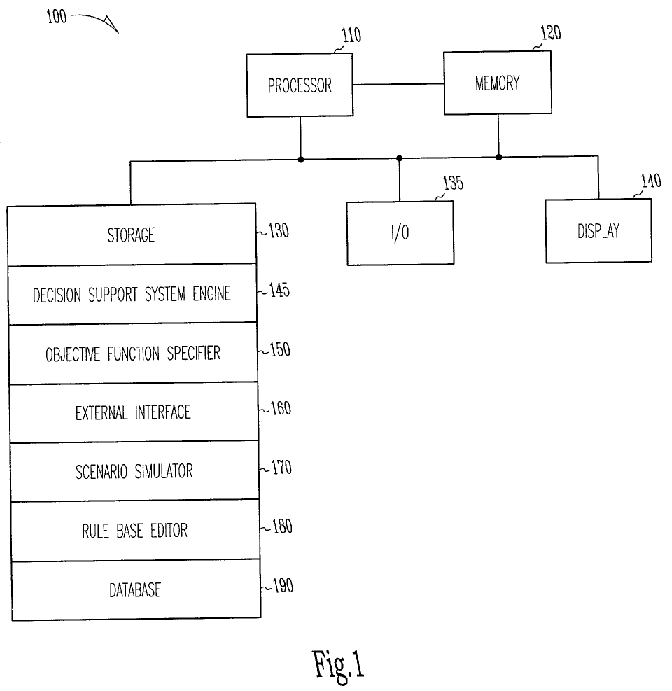

In one embodiment shown in a high level block diagram in FIG. 1, a computer system 100 comprises a processor 110 and memory 120. Computer programs execute on processor 110 and are stored on a coupled memory 120, which also represents various levels of cache. Coupled to the processor and memory is a storage device 130, I/O device or devices 135 and a display 140. The storage device 130 contains many programs, modules and functions which are paged in and out of memory 120 for execution on processor 110. Computer system 100 may also have network connections and other devices attached to it as desired, or operate as a server, interacting with distributed workstations at various airports or other locations. In one embodiment, the computer system is a personal computer system, but may be any form of system capable of performing the functions of the current invention.

Programs in storage 130 comprise a disruption handling system (DHS) that includes decision support system engine 145, objective function specifier 150, external interface 160, scenario simulator 170, rule based editor 180 and database 190.

Rule based editor (RBE) 180 provides graphical user interface (GUI) based functions that facilitate the ability of users to specify the rules for handling disruptions. Decision support system engine (DSS) is a GUI based application that collects incident reports (disruptions) information and provides a set of solutions based on the reported incidents. The DHS comprises an algorithm for the decision-making. Objective function specifier 150 (OFS) is a GUI based application to create/edit the objective function that is used to evaluate the candidate solutions.

External interface 160 (EI) is an interface, that provides the real time data needed for decision making. It is used to publish the current solution for a specific incident. Scenario simulator 170 (SS) is an application that simulates the outcome of the chosen scenario and provides measures of performance of the system.

It can be observed from Table 1 that on each day 5 aircraft will leave (schedules 1 to 5) Bangalore and 3 aircraft will return (schedules 10 to 12) to Bangalore. So to cater for the schedules starting from Bangalore on the next day, another two aircraft are required. In this process, there is a need for an indefinite supply of aircraft at Bangalore. Similarly, it may be possible for accumulation of aircraft at other airports, as there may not be any further trips out of those airports for that day. In addition, each aircraft after completing its journey will be left idle for the rest of the day.

However, as an airline will have a limited number of aircraft (fleet) at its disposal, it is not possible to follow the above approach. Hypothetically, although it is assumed that such a fleet is available, it is not economical as the utilization of the aircraft will be very low. Therefore, an airline would like to use the same aircraft for different schedules by rotating the aircraft among schedules. For example, the aircraft A001 after finishing its journey by reaching Cochin at 7.50 a.m. can be used for flight 9W3512 starting from Cochin at 8.20 a.m. reaching Bangalore at 9.40 a.m. Subsequently the same aircraft can be used to cater for flight 9W3513. Hence, aircraft A001 is rotated among flights 9W3511, 9W3512, and 9W3513. This rotation is also known as a pattern for an aircraft.

As an example, assume that the following three patterns need to be serviced for a set of schedules on each day of the week.

Pattern 1: 1-4-5-7-8-12-16-18-19-24-1

Pattern 2: 2-3-8-12-2-1-14-15-20-21

Pattern 3: 21-9-7-6-5-4-2-1-6-2

Where, 1, 2 . . . ,21 are identifications of airports for each of the patterns.

Pattern-1 starts from airport 1 and terminates at airport 1 and let it be assumed that it is serviced by an aircraft A001. Therefore, aircraft A001 starts its life in a day with airport 1 and reaches airport 1 for the night halt. This halt is known as layover for the aircraft.

Similarly, pattern 2 starts from airport 2 and has a layover at airport 21 and pattern 3 starts from airport 21 and has a layover at airport 2. Let us assume A002 and A003 service pattern-2 and -3 respectively for the first day (time). Logically, it can be deduced that A002 after servicing pattern-2 can service pattern-3 for the next day and A003 after servicing pattern-3 can service pattern-2 for the next day.

In this approach, an airline requires only three aircraft to service the above three patterns. In both the above cases, the number of patterns starting from an airport is equal to the number of aircraft ending at that airport. This will ensure that no aircraft is left idle and does not require an indefinite supply of aircraft (as discussed in the limitations of the approach, where an aircraft is assigned for each schedule).

Therefore, the objective of an airline is to generate patterns that can accommodate schedules with minimum (or given) number of aircraft. The constraints for assignment of the patterns are as follows.

1. Minimum “ground activity time” is required for an aircraft to service two consecutive trips (schedules). This “minimum ground activity” time is assumed dependent on the type of aircraft, airport and the time of the day. The rational behind this approach is to build some slack time in the patterns so that although a flight is delayed, it will not have the cascading effects down the line.

2. The number of aircraft that can be “layover” at a specific airport is limited depending on the airport.

3. It may be required that a pattern must always follow a hub and spoke pattern. A hub and spoke pattern is that a pattern which revolves around a central hub (airport) so that an aircraft can undertake trips between the hub and the other airports in its proximity. For example, the following pattern is a hub & spoke pattern where “A” is the hub.

A→B→C→A→D→A→E→G→A→B→F→A

An automatic solution for this problem generates patterns by taking the schedules and constraints as inputs. Sometimes, it is possible that the schedules provided by an airline contain redundancy.

TABLE 3
A subset of schedules

| | | | Flight | Departure | Arrival | Days of | Type of |
|---|---|---|---|---|---|---|---|
| Number | Origin | Destination | No. | Time | Time | Operation | Aircraft |
| 13 | Delhi | Jaipur | 9W | 5:55:00 | 6:55:00 | Daily | ATR |
| | | | 3401 | AM | AM | | 72-500 |
| 14 | Jaipur | Udaipur | 9W | 7:35:00 | 8:40:00 | Daily | ATR |
| | | | 3401 | AM | AM | | 72-500 |
| 15 | Delhi | Udaipur | 9W | 5:55:00 | 8:40:00 | Daily | ATR |
| | | | 3401 | AM | AM | 72-500 | |

For example, from table 3 it can be observed schedule 9W 3401 originates at Delhi at 5.55 a.m. and terminates at Udaipur at 8.40 a.m. Similarly another schedule 9W 3401 (bearing the same number) originates at Delhi at 5.55 a.m. and terminates at Jaipur at 6.55 a.m. In addition, another schedule originates at Jaipur at 7.35 a.m. and terminates at Udaipur at 8.40 a.m. It can be deduced that the schedule leaving Delhi and reaching Udaipur is a superset of the other two schedules. Since schedule number 15 can also be accomplished by the sum of schedules 13 and 15, schedule 15 is a pattern for the other two schedules. Such cases may need to be reported to the airline and removed from the list of schedules to arrive at the patterns.

The assignment of an aircraft to a pattern needs to consider the following aspects

1. The availability of a specific aircraft type

2. The maintenance schedule of the aircraft under consideration

3. The flying range of the aircraft. For example, a specific aircraft type may not fly more than a specific number of hours.

4. Airport restrictions for specific aircraft types

5. The load balancing of the aircraft utilization

6. That aircraft must pass through a specific airport

Load balancing of the aircraft utilization can be explained by considering the following schedules. For example, consider the following patterns in Table 4

TABLE 4
example patterns

| | Starting | Flying | Flying |
|---|---|---|---|
| Pattern | Airport | Cycles | Hours |
| One | Mumbai | 10 | 8 |
| Two | Mumbai | 9 | 6 |
| Three | Bangalore | 12 | 7 |

It can be observed that both the patterns One & Two start from Mumbai, daily. Assume two aircraft A &B are assigned to pattern-1 and pattern-2 respectively on a regular basis. Then over a period of time, aircraft A will be over utilized in comparison with aircraft B. This factor needs to be considered for tail assignment.

For the first version of the tool, it is assumed that the data required for pattern/tail assignment is available in the system. This is accomplished through ingesting the customer-supplied data in to the system's database 190.

For pattern assignment, the solution consists of arriving at the patterns by heuristic approach. Initially, the user is displayed with the schedules of the Airline. The user selects the pattern assignment function, whereby a set of redundant schedules identified by the system is presented to the user. The user then selects the flights that he/she perceives to be included for pattern assignment. That will result in a set of flight schedules to be used for the pattern assignment. The user executes the pattern assignment function, which will result in the display of a GNATT chart with the pattern number associated with a set of flight schedules. When the user clicks on a particular schedule, the details of that schedule are displayed in the form of a window. The user can edit a flight schedule of a pattern so that the patterns can be customized. In this process, the user can come up with specific patterns of his/her choice. Verification of the patterns is carried out when a user builds the pattern. In other words, the compatibility among schedules of a user-built pattern is checked by the system to alleviate potential problems during disruption management.

Once the pattern assignment is over, the user selects the tail assignment function. If the patterns are not ready in the system, the system will advise the user that there are no available patterns. The tail assignment function displays a GNATT chart of the patterns and a set of available tail numbers. When the user requests the system to assign tail numbers, the pattern numbers in the GNATT chart are replaced by the tail numbers and the user is prompted to accept/reject the tail assignment. Alternately, the user can also assign a particular tail number with the pattern. The tail assignment will be one of the inputs to disruption management tool.

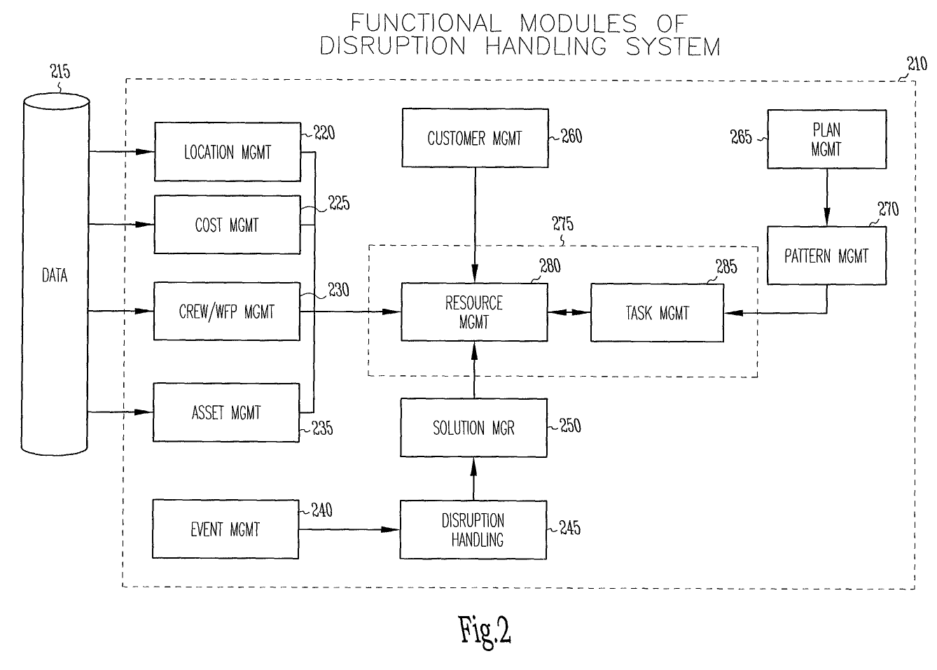

FIG. 2 is a block diagram showing functional modules of a disruption handing system generally at 210. The modules are performed by processor 110 with human interaction as desired. A database 215 contains information about an airline, including airport restrictions, costs, crews, and assets. The data is obtained from database 215 by multiple modules corresponding to each type of data to feed to the other modules. In this embodiment, data retrieval modules comprise location management 220, cost management 225, crew/WFP management 230 and asset management 240. Location management 225 retrieves data about airport locations, such as runway information and various restrictions regarding takeoffs and landings, types of aircraft permitted, etc. Cost management 225 retrieves all required cost information to compute the cost of servicing a route. Crew/WFP management module 230 extracts crew data or work force plant data to determine availability and qualifications of crews to service flights. Asset management module 240 contains aircraft data, such as the number of seats and maintenance schedules. Much more information may be obtained by these modules depending on the complexity of disruption handling cost and simulation desired.

An event management module 240 receives indications of events from human users or other system users. The event information is fed to a disruption handling module 245 which proposes multiple solutions. Passenger information, including reservations is provided by a customer management module 260. Overall flight schedules and plan management is provided by a plan management module 265, and patterns to service the flight schedules is provided by a pattern management module 270.

An overall management module for servicing the patterns is indicated at 275, and includes a resource management module 280 and task management module 285. These overall management modules receive solutions to disruption from solution management module 250, crew information from crew/WFP management module 230, customer data from customer management module 260 and pattern information from pattern management module 270. The task management module 285 assigns times and dates for patterns, effectively handling the plan that needs to be serviced. The resource management module 280 manages the resources required to service the plan.

Once the tail assignment is made, the aircraft is ready to service a flight. Often the operations of airline can be subjected to disruptions because of factors such as, weather, airport restrictions, aircraft unavailability and a variety of other reasons. These disruptions can have a cascading effect so that disruption at one location could result in some other locations. For example an arrival flight delay could result in the passenger (on that flight) missing connections; crew missing their next duties; non availability of this aircraft for subsequent flights etc.

The following Table 5 shows typical disruptions with proposed solutions and cascading effects associated with those proposed solutions.

TABLE 5
Typical Disruptions

| Primary Problem | | |
|---|---|---|
| (on top of | | |
| current constraints) | Action | Cascading Effect |
| Airport restrictions | | |
| Equipment restriction at an | Divert/Skip, Cancel, Hold (delay) | Arrival Flight Delay, |
| Airport | | Flight Cancellation |
| Runway problems in one | Divert/Skip, Cancel, Hold (delay) | Arrival Flight Delay, |
| ore more airports | | Flight Cancellation |
| Night Bans | Divert/Skip, Cancel, Hold (delay) | Arrival Flight Delay, |
| | | Flight Cancellation |
| Accidents/Acts of God | Divert/Skip, Cancel, Hold (delay) | Arrival Flight Delay, |
| | | Flight Cancellation |
| Political Disturbances | Divert/Skip, Cancel, Hold (delay) | Arrival Flight Delay, |
| | | Flight Cancellation |
| Employee Strike | Divert/Skip, Cancel, Hold (delay) | Arrival Flight Delay, |
| | | Flight Cancellation |
| Watch outs (?) | Divert/Skip, Cancel, Hold (delay) | Arrival Flight Delay, |
| | | Flight Cancellation |
| Weather | | |
| Reduced Visibility | Divert/Skip, Cancel, Hold (delay) | Arrival Flight Delay, |
| | | Flight Cancellation |
| Weather problem at one or | Divert/Skip, Cancel, Hold (delay) | Arrival Flight Delay, |
| more airports | | Flight Cancellation |
| Maintenance Restrictions | | |
| Maintenance Schedules | Postpone Maintenance Check | Possible Aircraft |
| | | Snags, Aircraft |
| | | Availability |
| Aircraft Problems | | |
| Snag on Ground | Swap with Spare, Swap with a | Departing Flight |
| | different Flight, Hold | Delay, Aircraft |
| | | Availability |
| Equipment problem in an | Swap with Spare, Swap with a | Departing Flight |
| aircraft (MEL) | different Flight | Delay, Aircraft |
| | | Availability |
| Snag during Flight | Add enroute stop | Arrival Flight Delay, |
| | | Flight Cancellation |
| Aircraft Availability | Cancel | Flight Cancellation |
| Ground activity problem | | |
| Minimum Ground Time | Accept | Departing Flight |
| Violation | | Delay |
| Gate unavailability | Delay, Use of tarmac space and | Arrival/Departure |
| | buses | Flight Delay |
| Catering problem, | Delay, Reduce ground time, | Departing Flight |
| Cleaning problem, Other | | Delay |
| ground activities) - delay | | |
| Fuelling Delay | Delay, Reduce the fuelling time | Departing Flight |
| | | Delay |
| Baggage Loading | Delay, Book Baggage on other | Departing Flight |
| | Flight | Delay |
| Airobridge unavailability | Delay, Transfer pax with bus | Arrival/Departing |
| | | Flight Delay |
| Pax, Cargo related | | |
| Passenger delay | Delay the connection flight, Book | Passenger Delay |
| | passenger on other flights | |
| | (recursive for next flights), | |
| | Arrange with a tie-up, Passenger | |
| | Refund, Add enroute stop on | |
| | another flight | |
| Baggage missing | Book baggage on next flight | Baggage Delay |
| Overload of passenger | Book passenger on other flights | Passenger Delay |
| | (recursive for next flights), | |
| | Arrange with a tie-up, Passenger | |
| | Refund, Add enroute stop on | |
| | another flight | |
| Overload of Cargo | Book baggage on next subsequent | Baggage Delay |
| | flights | |
| Passenger Emergencies | Add enroute stop, Accept (Delay) | Arrival Flight Delay |
| Under load of Passenger | Book passenger on other flights | Passenger Delay |
| | (recursive for next flights), | |
| | Arrange with a tie-up, Passenger | |
| | Refund | |
| Crew Related | | |
| Crew Emergencies | Add enroute stop | Arrival/Departing |
| | | Flight Delay, Crew |
| | | Availability |
| Incoming crew delay | Hold (Delay), Swap with other | Arrival/Departing |
| | crew | Flight Delay |
| Crew delay at the terminal | Hold (Delay), Swap with other | Departing Flight |
| | crew | Delay |
| Minimum Crew | Accept (Delay) | Departing Flight |
| Connection Time | | Delay |
| Crew unavailability | Re-crew, Accept reduced crew - | Departing Flight |
| | plan onboard activities | Delay |
| | accordingly, Delay | |
| Reduced Crew | Re-crew, Accept - plan onboard | Departing Flight |
| | activities accordingly, Delay | Delay |
| Flight Related | | |
| Flight Cancellation | Swap with Spare, Swap with a | Aircraft Availability |
| | different Flight | |
| Arrival Flight Delay | Swap with Spare, Swap with a | Aircraft Availability, |
| | different Flight, Flight | Passenger Delay, |
| | Cancellation, Accept | Crew Availability |
| Departing Flight Delay | Accept, Reduce the ground | Arrival Flight Delay |
| | Activity | |

Disruption Handling

When disruptions occur, the user is prompted with a list of disruptions that the system is “aware” of and is requested to identify those disruptions that need to be resolved. Once a disruption is identified, the user is asked to enter the parameters of the identified disruption. For example, “arrival flight delay” is a disruption, whereas, the flight number and the amount of delay could be the parameters of this specific disruption.

In this manner, disruptions are entered on a continuous basis from different locations in the system. Alternately, the system itself can infer that a disruption has happened and could prompt the user to acknowledge the same. After the user acknowledgement, the disruption is considered for resolution.

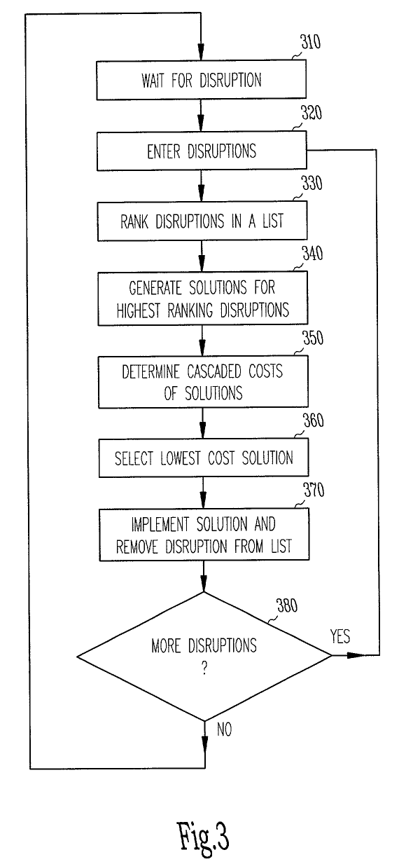

Once the disruptions are identified, the following operations broadly describe the process involved in arriving at a resolution as shown in FIG. 3.

1. Wait for the arrival of disruptions at 310

2. The disruptions are added to a “master-list” at 320 as they arrive.

3. The disruption handling mechanism (DHM) monitors the master-list periodically (configurable time interval) and obtains a “list of recent disruptions” to be resolved.

4. For each of the disruption in the list, its impact is evaluated (through simulation) when it is left unresolved. Then the disruptions are prioritized according to the impact at 330.

5. The priorities are presented to the user and the user is provided a choice to alter these priorities. The user can also choose to neglect resolving a disruption based on its impact. The DHM will remove this disruption from its list and rearranges the priorities based on the input.

6. For each of the disruptions starting with the highest priority, the DHM performs a simulation of all possible resolutions at 340. For example, if the arrival flight is delayed, the DHM simulates the effect of all the decisions that could be taken to resolve arrival flight delay. The cost of each of the decisions is also calculated at 350.

The user is presented with all the decisions and their (economic) value against a disruption. The user can select a particular decision of his/her choice at 360. In some embodiments, the selection is made by the DHM. Once a decision is selected, all other decisions that might use “the resources used in the selected decision” are made unavailable to the user.

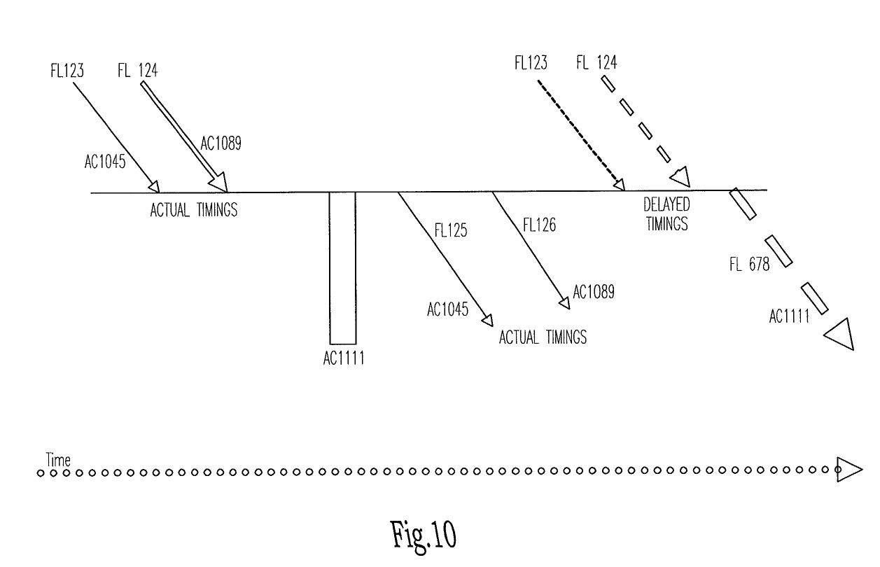

For example, let flights FL123 and FL124 (which were assigned to aircraft AC1045 and AC1089) in FIG. 10 are reported as delayed. Let it be assumed that the DHM suggests swapping aircraft AC1111 to resolve both the disruptions. If the user or system chooses to swap AC1111 with AC1045 (because of its high impact as explained in 3 and its suitability), automatically the suggestion to swap, AC1111 with AC1089 will be made unavailable to the user.

Several conclusions flow from the swap. Aircraft AC1045 has to fly FL125 after FL123. Aircraft AC1089 has to fly FL126 after FL124. Both FL123 and FL124 are delayed and hence FL125 and FL126 will be delayed. Aircraft AC1111 is available at this airport whose next flight if FL678. FL678's scheduled departure lies beyond the expected delayed arrival times of FL123 and FL124. The choice is to swap AC1111 with AC1045 or AC1089.

7. Once the user selects a decision, the impact of the decision is observed through simulation. The issue of the depth of the simulation is considered elsewhere. In addition, a user can simulate the effect of any random noise (as chosen by the user) on the decisions.

8. Based on the above observation, a user can “lock” the decision.

9. Once the decision is locked, accordingly the System State is updated at 370. For example, let us consider the example cited in step-6. If AC1111 is swapped with AC1089 (for FL123), then the tail assignment of AC1111 needs to be automatically changed/updated to reflect that of AC1045 for the rest of the period.

10. The process is repeated for all the disruptions as indicated at 380.

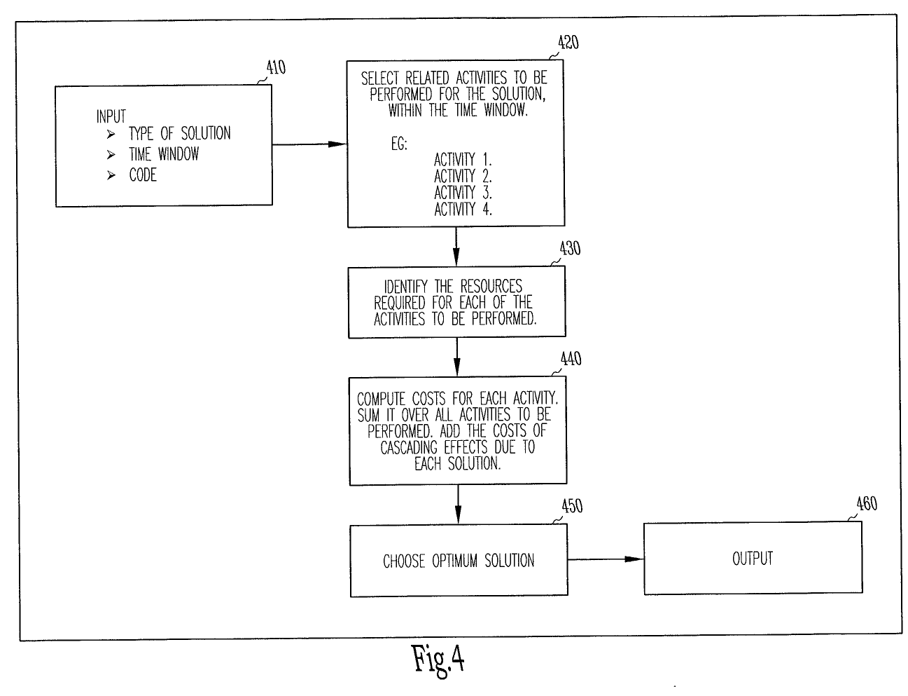

FIG. 4 is a block diagram of a cost function manager that determines the cascading costs of proposed solutions to interruptions based on time windows. Potential solutions to an interrupt are provided at an input block 410. The type of solution, a time window for the solution and a code representing the solution is provided. Related activities to be performed within the time window are selected at 420. Multiple activities may be required, and are predetermined for each solution. Resources required for each of the activities to be performed are identified at 430.

At 440, costs of the solutions are determined. Each resource has a fixed cost and a variable cost depending on the type of resource. The cost may change for different times. Gate availability cost may be different in a different time window. The costs for each of the activities are computed, and then summed over all the activities to be performed. The costs of cascading effects due to the solution are also added. The cost is provided to block 450, which compares the costs of the solutions and selects an optimum solution based on the resources used and the time window chosen. An output 460 provides a solution and related cost, or alternatively a set of solutions and their costs.

The time window is defined with a lower limit, and an upper limit. The time window is a period of time in which the candidate solutions for the disruption have to be found. It defines when resources are required for the activities, and allows marshaling of the same. It also provides a reference for determining the costs associated with the resources. In one embodiment of the invention, different time windows are proposed for the solutions. An iteration through multiple time windows is used in one embodiment to determine potential solutions.

User Interfaces

The following list presents some user interfaces 160 and their function.

1. Log-in—A UI for the user to log-in to the application. It validates the user credentials and warns/advises the user if the credentials are not correct. Allows the authorized users to access the applications. (not required for version—1)

2. Pattern Assignment—This screen will let a user perform the pattern assignment. It will present the user with the current schedules and allows the user to modify the schedules. It can also present a list of redundant flights from the existing schedules as observed by the system. It will present the generated patterns in terms of GANTT chart and facilitate the user to come up with his/her own patterns by editing the same.

3. Tail assignment—This screen will have the patterns and the available tails numbers (aircraft). It will allow a user to modify the aircraft characteristics. It will assign independent tail numbers to patterns and allows a user to assign a specific tail number to a pattern.

4. Initial Problem Set (disruptions either presented to the user or user need to enter the disruptions)—This screen presents the user with a pre-configured list of events that would qualify as a disruption.

Arrival Flight Delay (FLXXXX “is” delayed at “location” by ZZ:zz:zz hrs).

Departure Flight Delay (FLXXXX “will be” delayed at “location” by ZZ:zz:zz hrs).

Passenger Delay (Passengers [list of passengers] to be on FLXXXX at “location” are delayed)

Aircraft unavailability (ACXXXX “will not be available”/ACXXXX “is not available” at “location”)

Crew unavailability (E/C XXXX “will not be available”/“is not available” at “location”)

Crew Delayed (E/C XXXX on FLXXXX is delayed/will be delayed at “location” by ZZ:zz:zz hrs)

Dynamic Airport Constraints (Airport APZZZZZ has “codeYY”)

Dynamic Aircraft Constraints (Aircraft ACXXXX at “location” has “codeZZ”)

Gate is not available (Gate GAXXX at airport AXXXX is not available/will not be available between ZZ:zz:zz hrs and ZZ:zz:zz hrs)

Baggage Delayed (Baggage of passenger “PZZZZ” is delayed at “location” by “ZZ:zz:zz” hrs

Passenger Emergencies (Passenger “PZZZZ” on FLXXX at “location” has “codeZZZ”)

Forbidden Resolutions—This screen will present the user with various possible measures for a disruption. A user can select a set of specific measures that should not be considered by the system in arriving at a solution. Not required for the first version of the tool.

5. Impact of Initial Problems—This screen will present the impact of the problems if left unattended in terms of a list of cascading disruptions. Problem impact details—Each disruption in that list will have cost/penalty associated with the same. Problem Priority—This screen presents the user with the priorities of the disruptions as determined by the system. It will allow a user to modify the priorities of the disruptions.

6. Problem Resolution—This screen presents the set of solutions for each of the disruptions. Resolution Details—This screen presents the details of each of the solution.

7. Resolution Impact (Simulation—Results—Configurable Depth)—This screen presents the impact of a resolution when it is adopted. Not required for the first version

8. Resolution Publishing/Acceptance—This screen facilitates a user to accept/reject the resolution. Once the resolution is accepted, the user will be prompted whether to publish the resolution or not.

9. External Data (in real time)—This screen allows a user to send the data in real time.

10. Simulation conditions (disturbances, what if scenarios)—This screen allows a user to specify any conditions that need to be considered while simulating a solution.

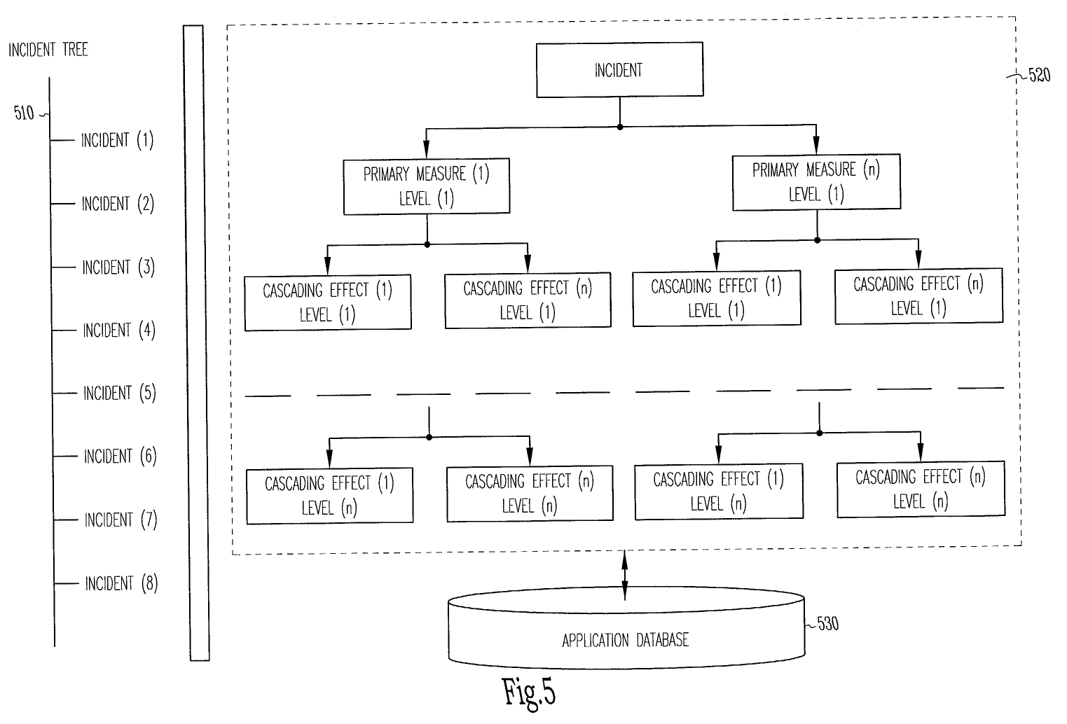

A rule based editor conceptual interface is shown in FIG. 5. An incident tree is provided on one side of the interface, identifying incidents 1-8, and allowing a user to click on an incident to evoke a measure tree for that incident. A top node of the tree 520 represents the incident, when then branches out into n primary measures in a first level. The measures represent a first level for potential solutions to an incident, or disruption. Cascading effects for the first level, and for a number of further levels are illustrated, allowing the user to control the level of cascading, and to specify the rules. New incidents may also be created. The rules and tree are stored for use by an application database 530.

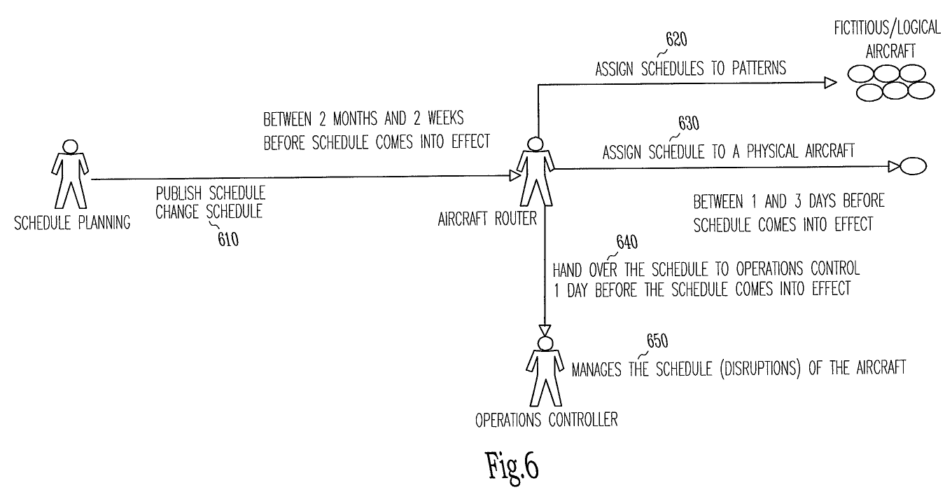

FIG. 6 is a workflow diagram illustrating schedule planning to disruption handling for an airline. First, a schedule is normally developed in a planning process at 610. The schedule is published between two months and two weeks prior to coming into effect. Patterns are assigned at 620 utilizing fictitious/logical aircraft. At 630, tail assignments are made based on physical aircraft. The schedule is then handed over to operations control at 640. Finally, schedule disruptions are managed at 650 by an operations controller.

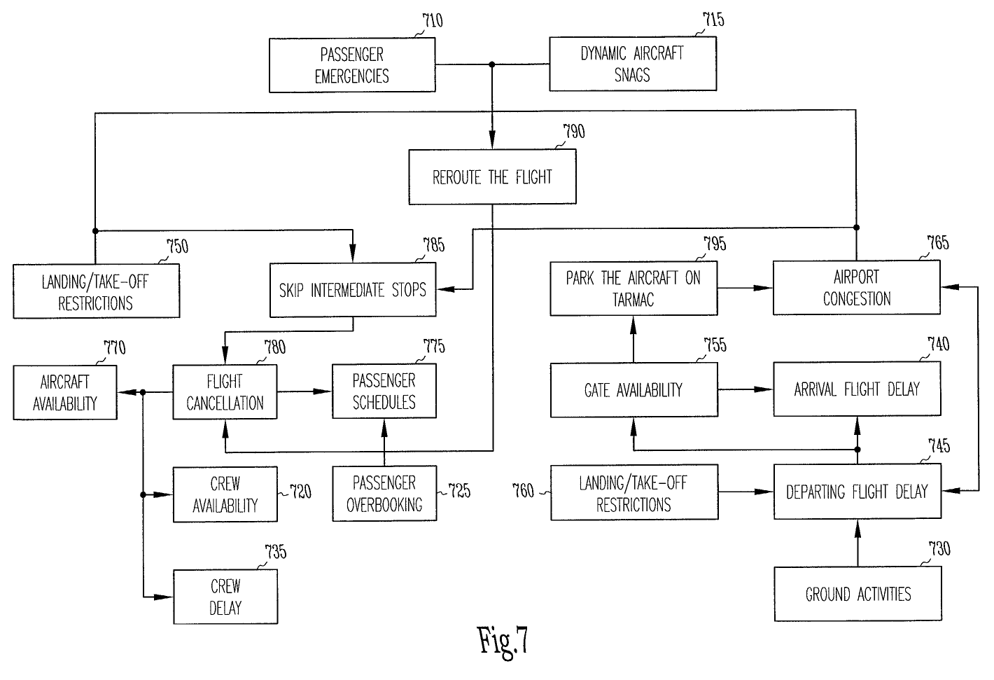

FIG. 7 is a block diagram of a domain model representing disruptions corresponding to passenger emergencies 710 and dynamic aircraft snags 715. This is one potential model, and other may easily be generated. This model shows triggers, incidents, issues and decisions. Passenger emergencies 710 and dynamic aircraft snags 715 are examples of external triggers. Internal triggers include crew availability 720, passenger overbooking 725 and ground activities 730. Incidents include crew delay 735, arrival flight delay 740 and departing flight delay 745. Issues that are not resolvable include landing and take-off restrictions 750, gate availability 755, further landing and take-off restrictions 760 resulting in departing flight delays, and airport congestion 765. Resolvable issues include aircraft availability 770 and passenger schedules 775. Several decisions are also represented including flight cancellation 780, skipping intermediate stops 785, rerouting flights 790 and parking the aircraft on the tarmac 795. As is apparent from the above, these are only a few of the triggers, incidents, issues and decisions that may be modeled. They are also related specifically to air traffic. The model is easily modifiable to represent manufacturing, distribution and other activities subject to schedules and potential disruptions.

Many of the above triggers, incidents and decisions have a direct effect on cost, such as rerouting flights 790, flight cancellation 780, crew availability 720, crew delay 735, parking the aircraft on the tarmac 795 and ground activities. The cost is included in the model as a cost per hour, cost per flight, cost per passenger, or other costs that can be determined or estimated, either as a function, or predetermined number.

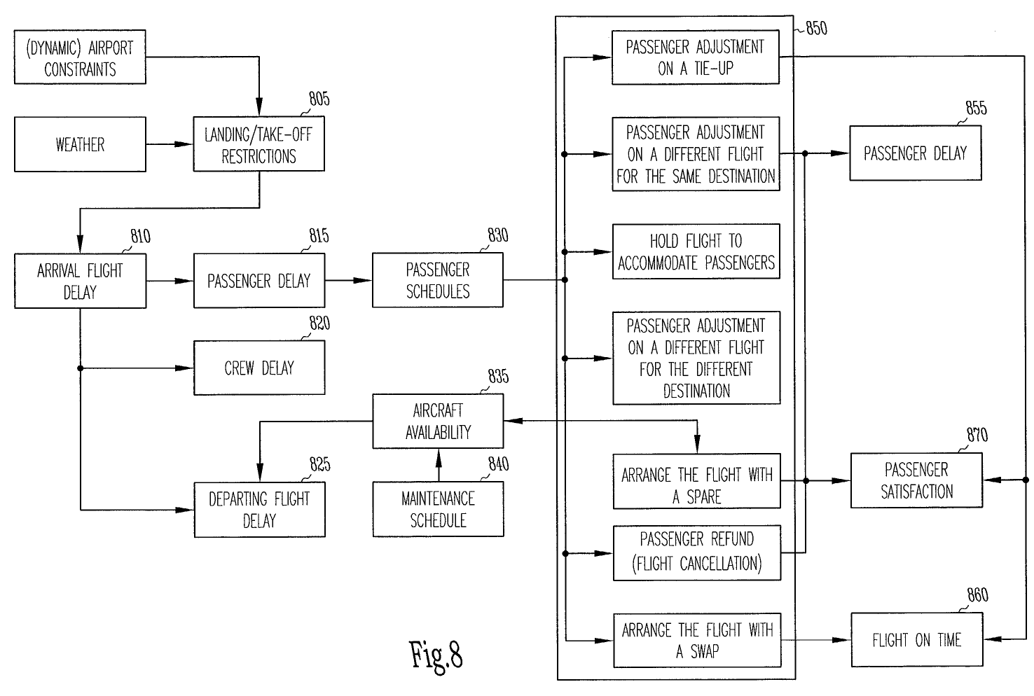

FIG. 8 is a block diagram of a domain model representing passenger connection resolution for restrictions. Dynamic landing and take-off restrictions 805 arise from dynamic airport constraints and weather. The restrictions result in arrival flight delay 810, potentially causing passenger delay 815, crew delay 820 and departing flight delay 825. Passenger delay 815 affects passenger schedules 830. Aircraft availability 835 can be used to resolve departing flight delay 825 at a cost associated with maintenance 840, and other costs partially illustrated in FIG. 8.

Passenger connection resolution 850 has several resolutions available, and each resolution has an associated cost. These resolutions include passenger adjustment on a different flight for the same destination, which causes passenger delay 855. Passenger adjustment on tie-up affects flight on time 860 and passenger satisfaction 870, which are the system objectives. Passenger delay also affects passenger satisfaction, which is also assigned a cost. Further resolutions include holding the flight to accommodate passengers, which may involve departing flight delay 825. Passenger adjustment on a different flight for a different destination may involve providing alternative transportation to the original destination. Flights may also be arranged using a spare aircraft, which depends on aircraft availability 835. Passenger refunds due to flight cancellation, or rewards for agreeing to different flights directly affect cost, and passenger satisfaction 870. Arranging the flight with a swap has potential cascading effects with associated costs.

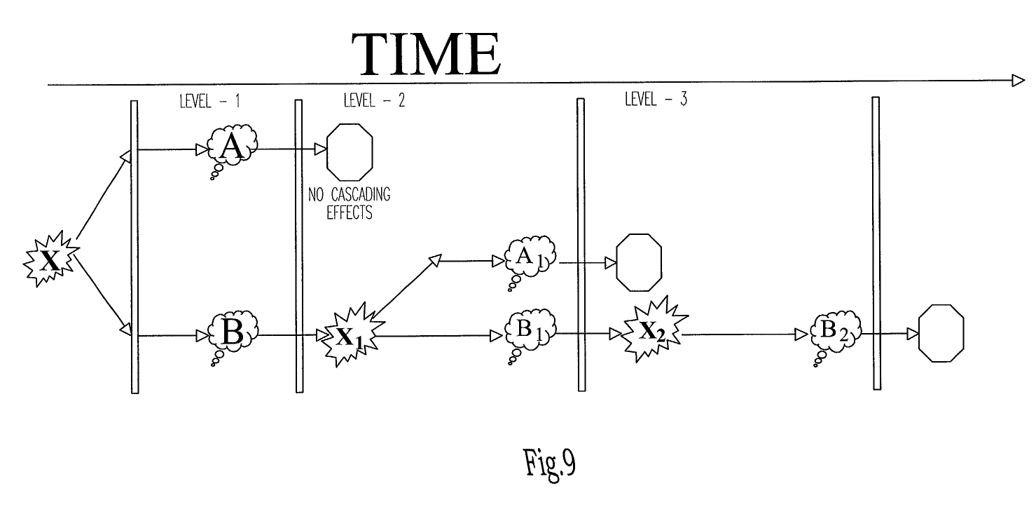

The purpose of simulation is to provide the user with the information regarding the cascading effects of a particular resolution. Such cascading effects are presented quantitatively. The user or system makes the decision based on the “total” monetary value of all the cascading effects of that decision. FIG. 9 illustrates a disruption X with two potential solutions A and B. Solution A has no cascading effects, but has a cost of 7000 units. The units may represent money, or some relative measure of overall cost of a solution. Solution B has a cascading effect of X₁, and has a cost of 2000 units. X₁ has two possible solutions A₁ and B₁. A₁ has no cascading effects, but has a cost of 4000 units. B₁ has a cascading effect X₂, and a cost of 2000 units. X₂ has a solution of B₂ which has a cost of 5000 units with no cascading effects.

The following deductions are apparent from FIG. 9:

X→A=7,000 units (no cascading effects)

X→B=2,000 units

X→B→X₁→A₁=6,000 units (no cascading effects)

X→B→X₁→B₁=4,000units

X→B→X₁→B₁→X₂→B₂=9,000units

Therefore, if only up to the first cascaded level is simulated, B seems to be a better resolution. However, when the simulation is extended to the second level, the resolution with A₁ has a cost of 6000 units, whereas, B₁ has total cost of 4000 units. If the simulation is extended to the third level, the resolution B₁ has a total cost of 9000 units. Therefore, from this example, it can be inferred that the resolution X→B→X₁→A₁ is the optimal solution.

In general, the simulation is performed for each possible resolution against all the cascading effects recursively or at the end of that business day. However, it is assumed that the system behaves in a predictive manner. For example, when resolution B is adopted, it will cause a disruption X₁ and solution or resolution of A₁ is taken for that specific disruption.

In one embodiment, the cost is computed for each resolution, and if any of the resolutions does not have cascading effects and its “total” cost is less (in comparison with others), simulating stopped, and that resolution is preferred.

In one embodiment of the disruption handling system, data is uploaded every day, either automatically or manually from a data model containing the schedules and potential disruptions with solutions. The decision is to swap AC1111 with AC1045, in FIG. 10, with an assurance that AC1045 will be used for FL678. However, if FL 123 is further delayed, then AC1045 will not be available and FL678 will be delayed. Therefore, the accuracy of the data will have a bearing on the resolution and the subsequent cascading effects.

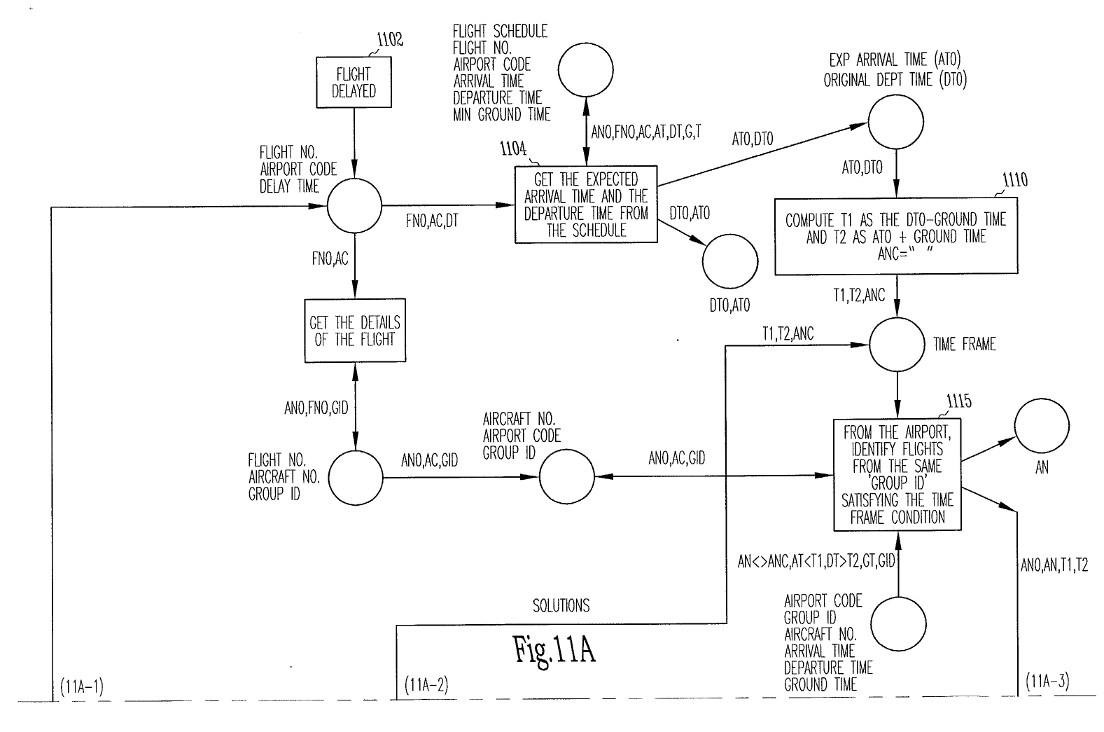

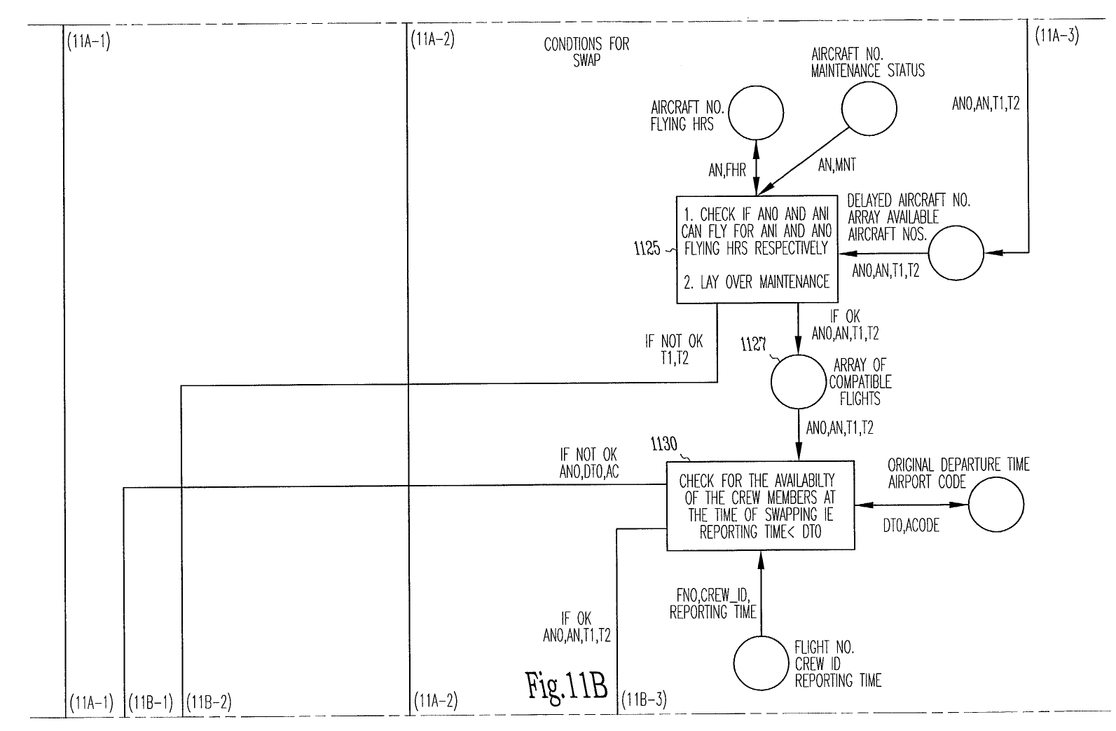

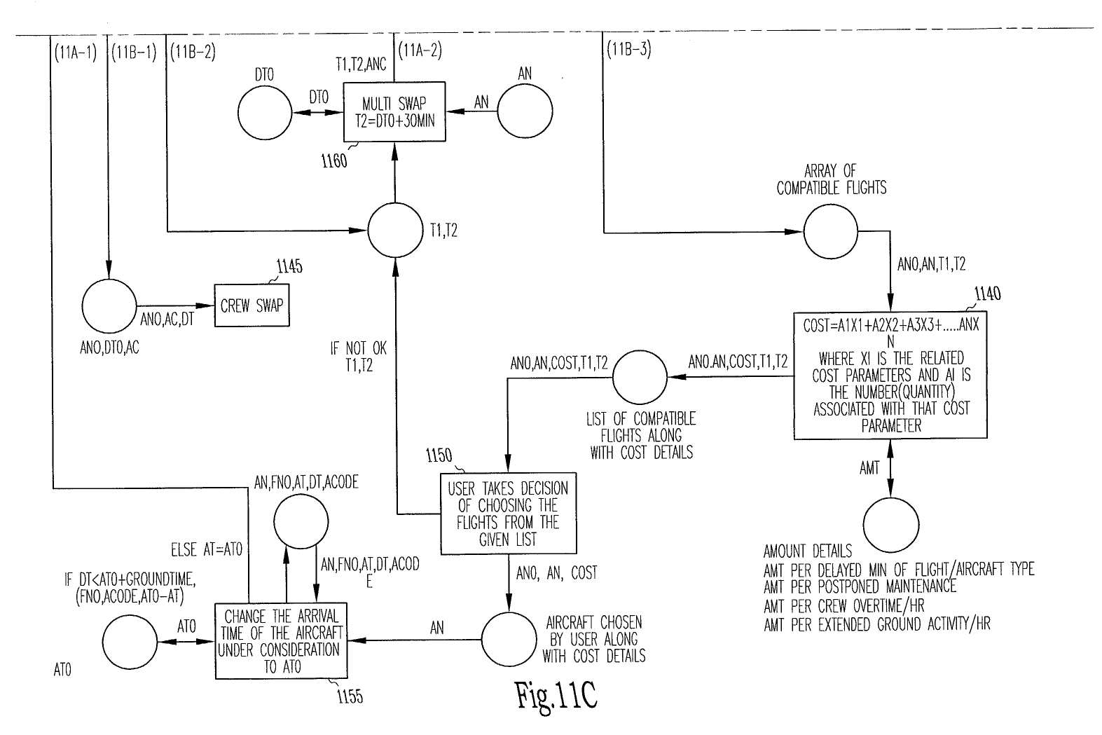

FIGS. 11A, 11B and 11C provide a colored Petri Net data flow model for disruption handling. In this representation, circles represent places (that which hold the tokens). The tokens here hold multiple types of data hence the term “colored”. When a token is fully populated, it feeds into a rectangle, which represents transitions. Transitions correspond to functions to be executed on the data. Thus, in a colored Petri Net, function or transitions are driven by data.

Colored Petri Nets are an extension of the more generally known Petri Nets, to handle multiple data types. In a general Petri Net only one type of data is allowed, that is the token is of only one color. But in a colored Petri Net, the multiple data types are represented by different colors; thus giving the flexibility to handle diverse data types. Petri Nets are made up of places, arcs and transitions. The place is the one that holds tokens that are required to fire a transition (start an event). The arcs perform the binding of the data types; here binding refers to matching the data types with the actual values during runtime. In colored Petri Nets, wherein there are multiple data types the arcs have to bind the corresponding data types. The approach of modeling the solution procedure using colored Petri Nets helps represent the concepts of sequence of events (synchronization) and identify concurrency, conflicts in the flow. This is not captured by other data flow modeling techniques like flowcharts, data flow diagrams or ER diagrams.

In FIG. 11A, disruptions are handled and entered into the database at 1102. Details of the flight are obtained, and expected arrival time and departure times are obtained at transition block 1104. A time window, or time frame, is calculated at transition 1110 as t1 and t2. t1 is the original departure time minus ground time, and t2 is the expected arrival time plus the ground time required. Given the time frame, potential flights satisfying the time frame are identified at transition 1115.

Once potential flights are identified, the feasibility of using the flights is determined at transition 1125, from a flying hours and maintenance feasibility perspective. An array of compatible flights is produced at token 1127 and provided to transition 1130 for determining the availability of crew members at the time or swapping of aircraft using constraint checks, transitions or events.

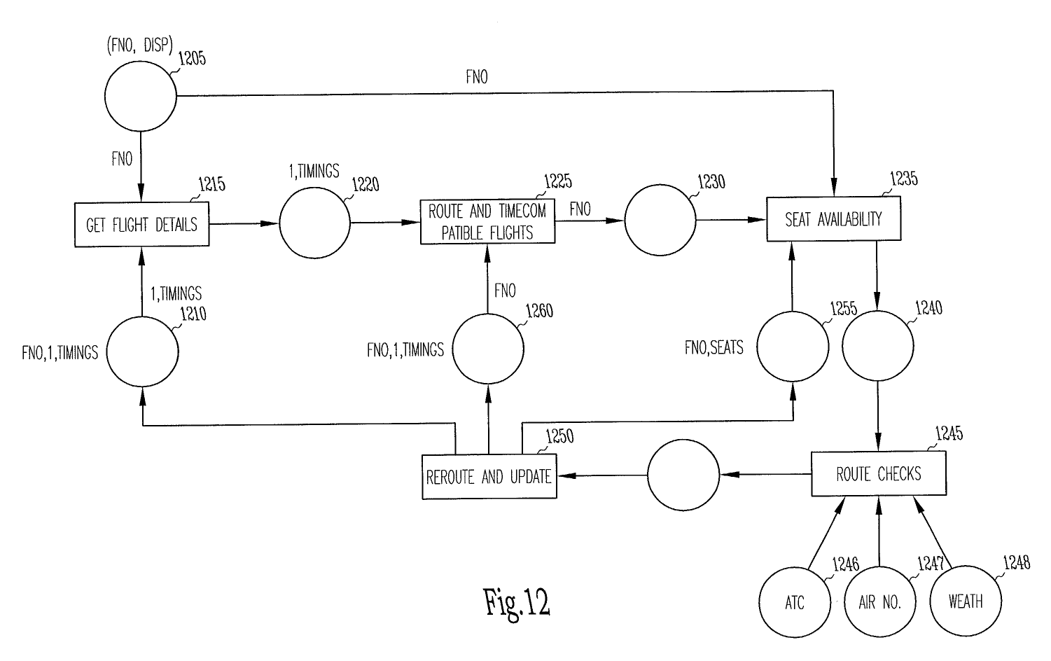

An array of compatible flights after the checking at transition 1130 is provided to determine cascading costs at transition 1140 for each compatible flight. Transition 1130 also provides information at a crew swap transition 1145 for producing instructions to crews to be utilized in light of a decision regarding a solution. At transition 1150, a user, or the system makes a decision, selecting one of the solutions, which may or may not involve swapping flights. The cost information is provided to the user to facilitate the decision. The decision is communicated to a transition 1155 that changes the arrival times of aircraft in accordance with the decision, and to a multi-swap transition 1160 that selectively increases the time window by adding a standard ground time of 30 minutes. If at 1155, dt<at0+ground time, then (fn0,acode,ato−at) is passed on to update flight numbers and delay times for 1104. The time window may also be increased in an iteration if no compatible flights are found. FIG. 12 is a data flow diagram illustrating the flow of data when the possibility of rerouting is encountered, and the generation of a list of options for rerouting of schedules. Disruption information 1205 and flight timings 1210 are provided as flight details 1215. Timings of the flights 1220 are provided to 1225, where other compatible flights are obtained. The flight numbers 1230 are fed to determine seat availability at 1235, which also receives the disruption information 1205. Flights having seat availability are provided 1240 to a route check 1245, which also receives air traffic control checks 1246, airport numbers 1247 and weather information 848. The results of the route check are provided for rerouting and updating of schedules at 1250. From 1250, flight numbers and timings 1260 are provided to 1225 where other compatible flights are obtained, and flight numbers and seats are provided to seat availability 1235.

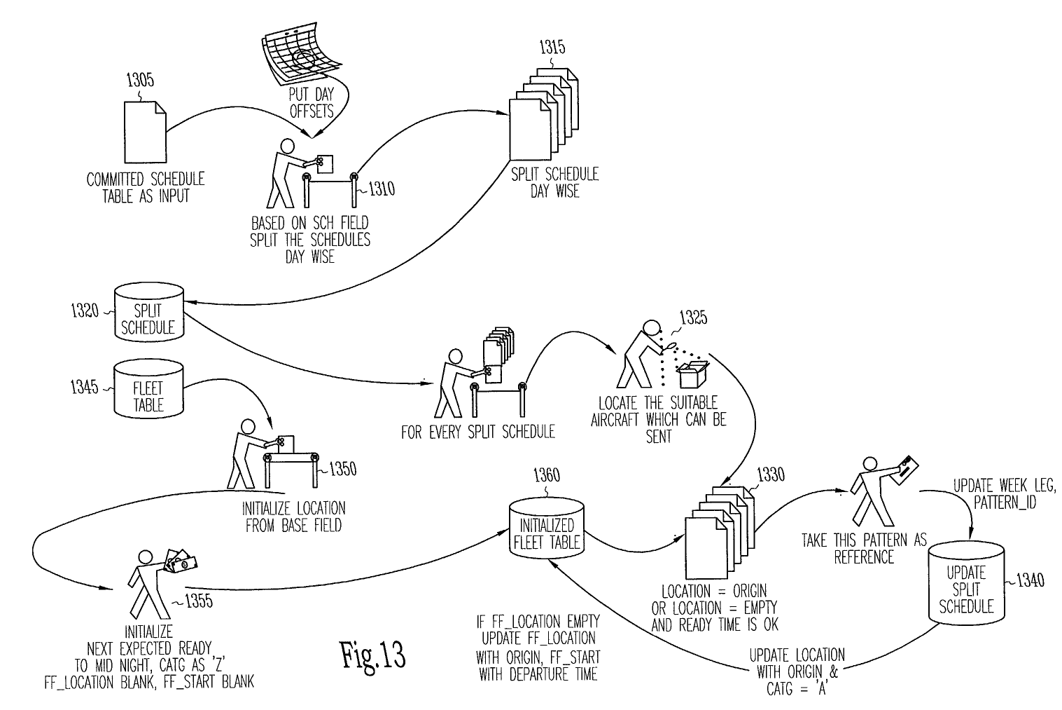

Further detail regarding pattern assignment is shown in the workflow diagram of FIG. 13. A committed schedule 1305 is used as input to a schedule splitter at 1310, which also includes put day offsets. The schedule is split day wise as shown at 1315 and stored in a database at 1320. For every split schedule, suitable aircraft are located at 1325, and assigned at 1330. This assigned pattern is taken as a reference and used to update the split schedule database at 1340. A fleet table 1345 is used to initialize locations from a base field at 1350, and a next expected ready aircraft is initialized at 1355 and used to initialize the fleet table at 1360. The fleet table is used at 1330 for assignment. As the split schedule is updated at 1340, the information is used to update the fleet table 1360.

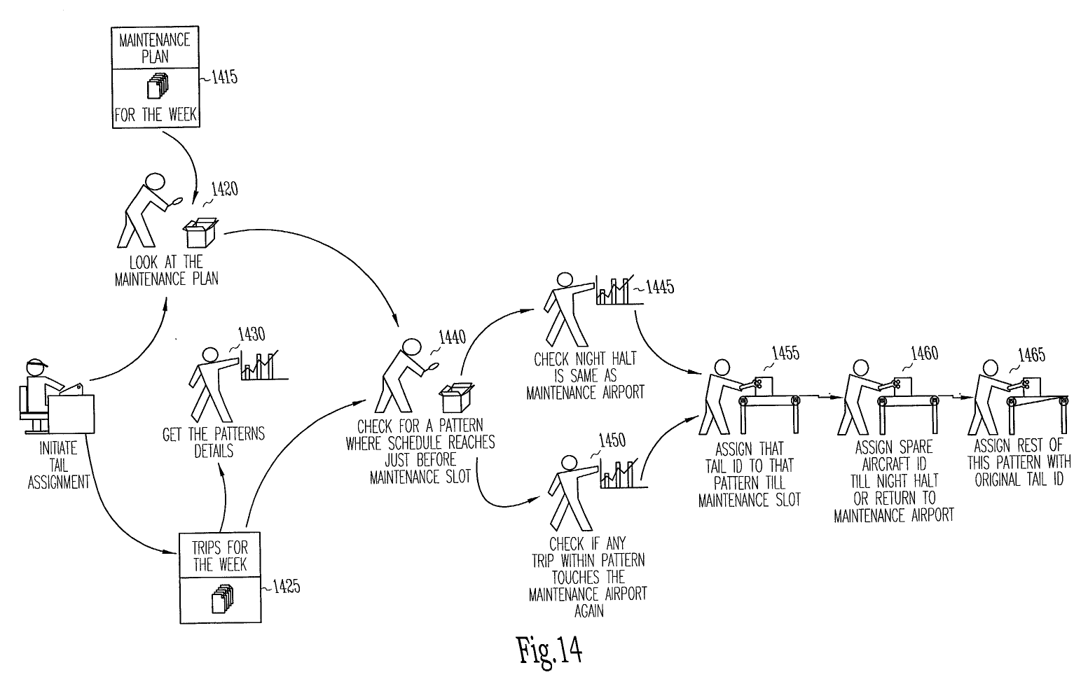

Tail assignment detail is provided in the workflow diagram of FIG. 14. Tail assignment is initiated at 1410, and a maintenance plan 1415 is provided for viewing or processing at 1420. Trips for the week 1425 and pattern details 1430, along with the maintenance plan 1420 are provided for a check for a pattern where the schedule reaches a point just prior to a maintenance time slot at 1440. A check is then made to determine whether the last flight for a pattern ends at the maintenance airport at 1445, or whether any trip in the pattern touches the maintenance airport at 1450. The tail ID is then assigned to that pattern until the maintenance slot is reached at 1455. Spare aircraft are assigned to the pattern until the night halt, or end of the pattern for the day at 1460, or until return of the pattern to the maintenance airport. Finally, the rest of the pattern is assigned with the original tail ID.

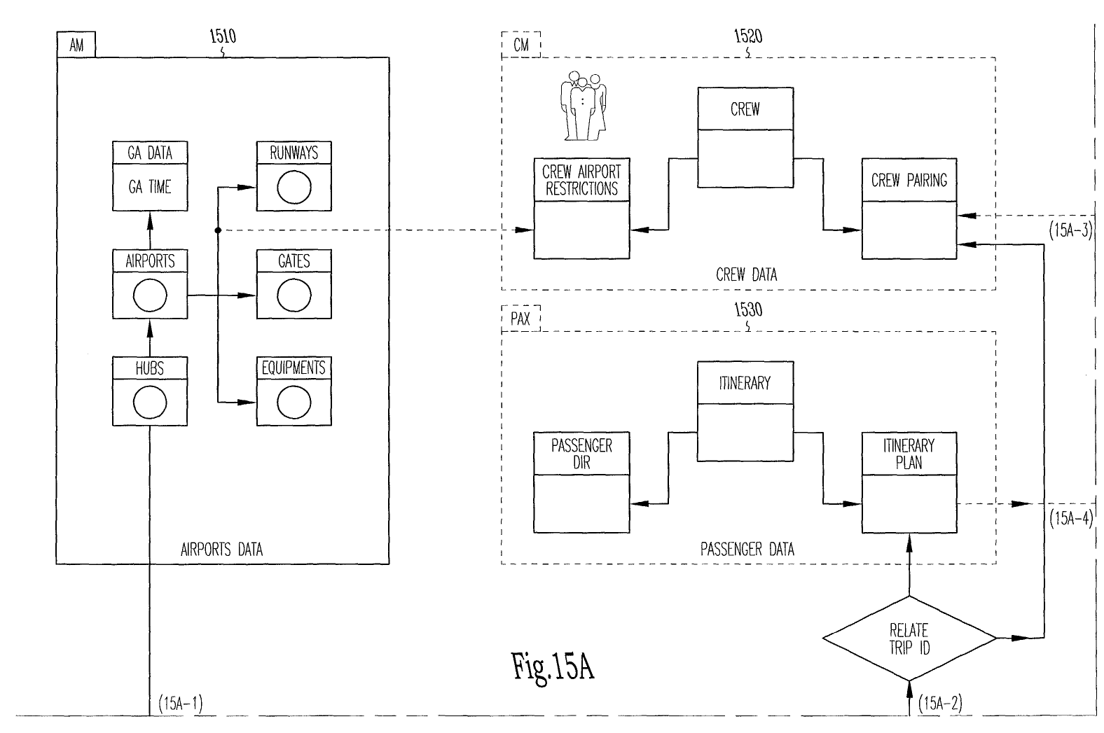

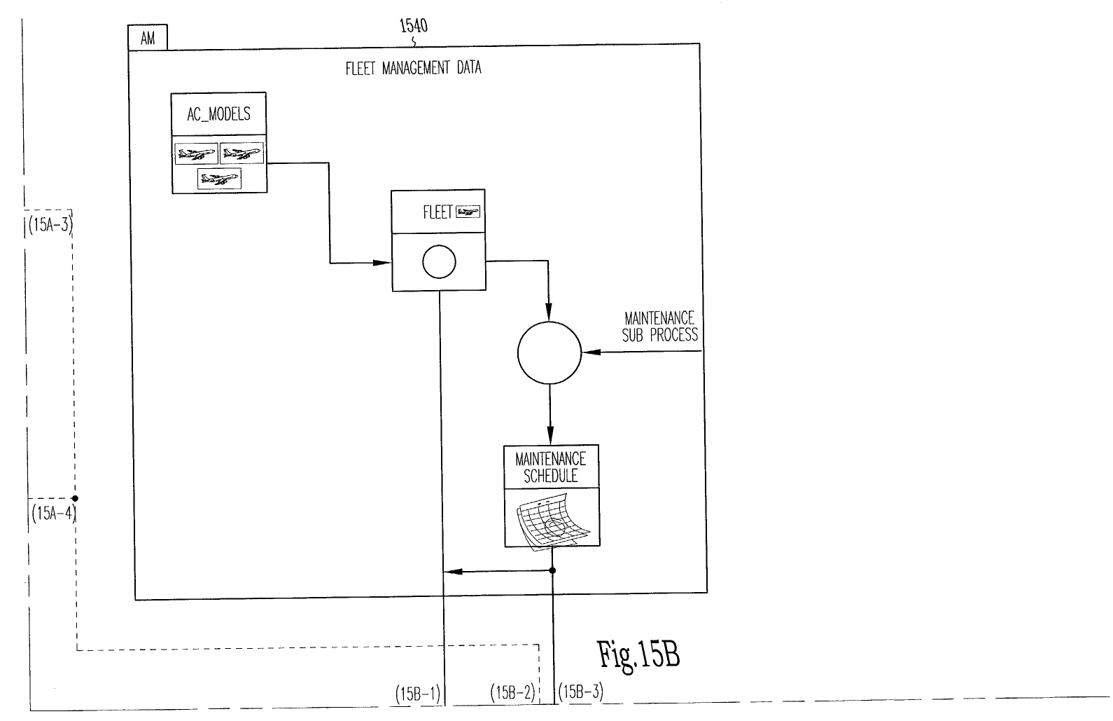

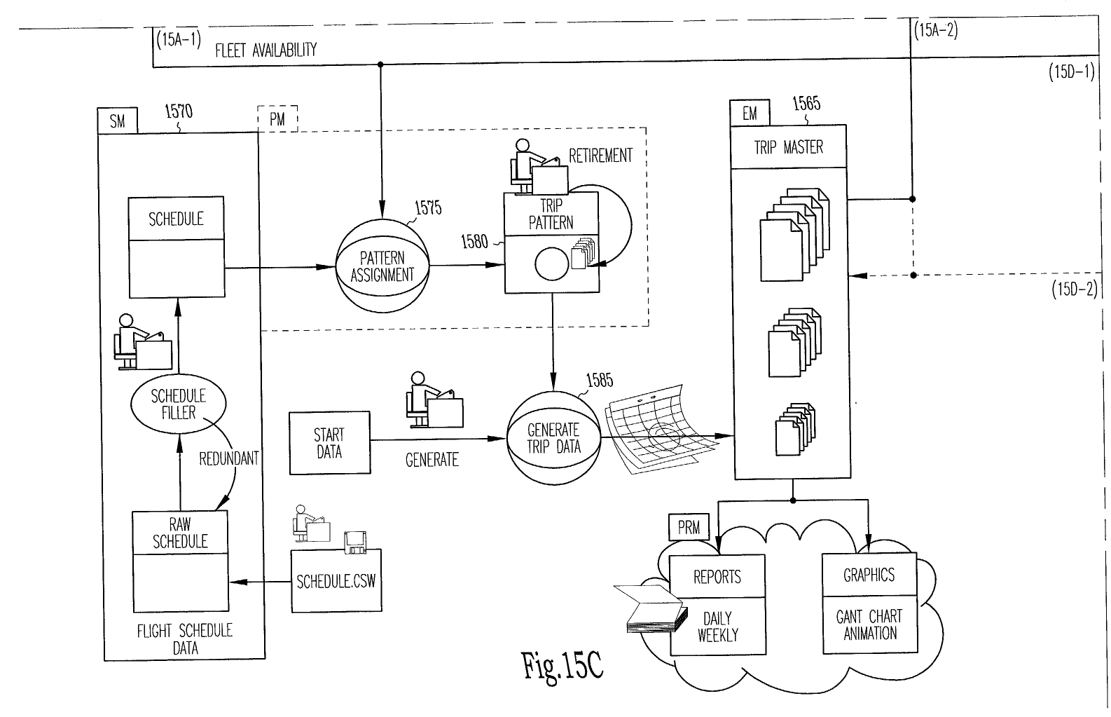

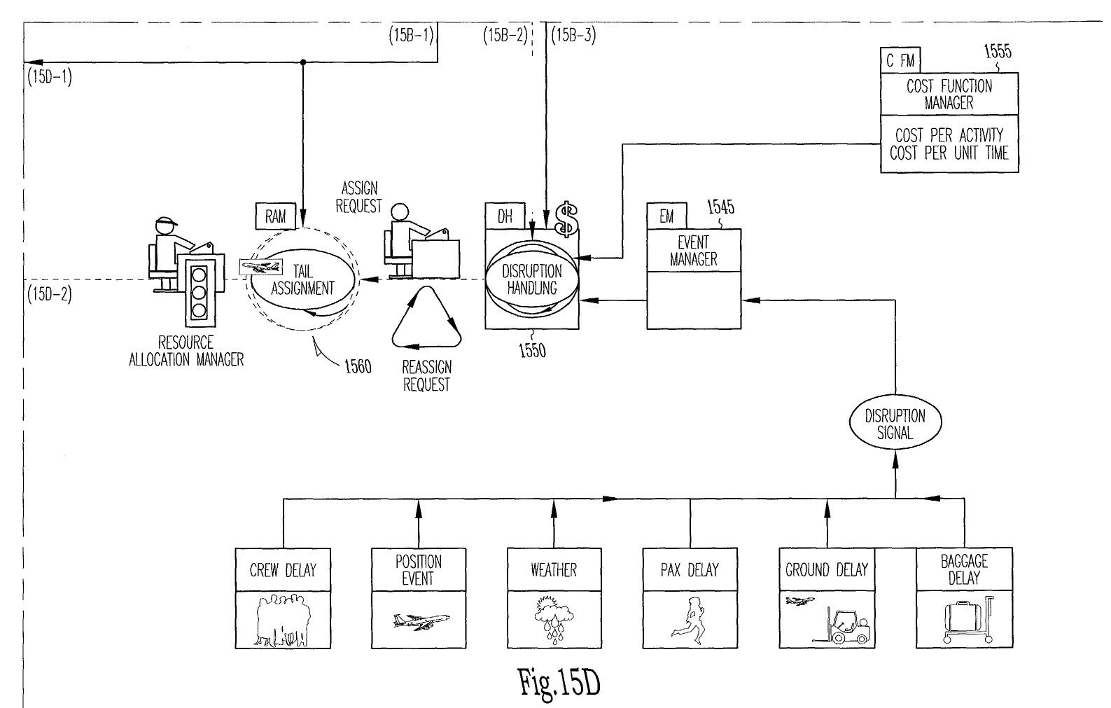

FIGS. 15A, 15B, 15C and 15D represent an overall flow diagram of an airline management system that handles disruptions. The figures contain representations of human users, databases and functional modules executed on a computer. It should be noted that many of the functions may be performed by computer or human, and no restriction on the performer of a function is intended.

FIG. 15A shows information in a database, such as airport data 1510, crew data 1520 and passenger data 1530. The data is used to accomplish the functions of the airline management system as previously described. It is provided to multiple different functions of the system as illustrated.

FIG. 15B shows fleet management data 1540, including aircraft model data in the fleet, maintenance data and a maintenance schedule. A event manager 1545 receives event information, such as crew delay, position delays, weather delays, PAX delay, ground delay and baggage delay to name a few. A disruption manager 1550 in FIG. 15D receives the event information from the event manager 1545 and also receives cost information from a cost function manager 1555. Solutions to disruptions are provided to a tail assignment function 1560, and ultimately to a trip master 1565 for servicing.

Trip master 1565 is initialized each day to a mast schedule. The master schedule is generated by a schedule filler 1570 that uses travel demand information to develop the mast schedule. Patterns are initially assigned at 1575, trip patterns are generated at 1580 and trip data for the trip master is generated at 1585. Multiple text reports and graphic displays are generated to provide information about the trip master information.

In FIGS. 15A, 15B, 15C and 15D, multiple links are shown between data and functions. Many of the functions require the same data, or at least data from the same database. The Colored Petri Net representation in FIGS. 11A, 11B, and 11C represent some of these links in a different manner.

### Conclusion

While the present invention is described in the context of an airline scheduling system, it is also applicable in several different environments.

In a manufacturing plant, a production plan (airline schedules/time table) is arrived to manufacture different products (passenger trips) based on historical data and market intelligence. This production may involve a number of steps (itinerary) to realize the product (trip) using different resources, such as machines (aircraft), plants (airports) and labor (crew). Since the same set of resources are used for producing different products, an optimum sequence or rotation (pattern) of resources needs to be arrived. A Production schedule is derived based on realizing the pattern. A production schedule can cater to many orders from many customers.

Once orders are received from the customers (passengers) and accepted, these orders are linked to a specific production schedule (daily trip). In other words, all related information would be then tied up to specific machinery (aircraft), specific crew etc. This may be referred as “late-binding” allowing the resources to be optimized at the Last/Exact moment.

During production, various disruptions such as machine failures, machine delays, material shortages, and loss of quality, wastage, transport delays (similar to disruptions occurring at an airport) can hamper the production. A Production Scheduler (Operations Controller) needs to resolve these disruptions with minimum or no loss to the enterprise.

In (a military domain) a battlefield, strategic plans (schedules/timetables) are arrived to attack the enemy based on military intelligence and other sources of information (customer info). This plan may involve a number of steps to realize the mission using different resources, such as equipment (aircraft), locations (airports) and soldiers (crew). Since the same set of resources is used for carrying out different operations, an optimum sequence or rotation (pattern) of resources needs to be arrived at. Once a decision has been made to attack the enemy positions (passenger data), the strategic plan is realized in the form of a mission (trip). In other words, resources (aircraft, crew) are allocated to missions.. During an operation/mission, various disruptions such as equipment failures, transport delays, casualties (similar to disruptions occurring at an airport) can hamper the mission. A mission/operations chief (Operations Controller) needs to resolve these disruptions with no casualties and minimum deviation from the strategic plan.

In a software company, a software development plan (airline schedules/time table) is arrived to develop different software products (passenger trips) based on historical data and market intelligence. The software development may involve a number of steps (itinerary) to realize the product (trip) using different resources, such as computers (aircraft), locations (airports) and Engineers (crew). Since the same set of resources is used for producing different products, an optimum sequence or rotation (pattern) of resources needs to be arrived. Once the orders from customers (passengers) are accepted, the plan is realized in the form of a production schedule (daily trip). In other words, resources (aircraft, crew) are allocated to orders. During production, various disruptions such as computer failures, development delays, machine shortages, and loss of quality, wastage, Engineers expertise, Experts health, other mishaps (similar to disruptions occurring at an airport) can hamper the production. A Project Manager (Operations Controller) needs to resolve these disruptions with minimum or no loss to the enterprise.

What is claimed is:

1. A method of handling disruptions to a plurality of related schedules, the method comprising:
prioritizing the disruptions in a list;
for the highest priority disruption in the list:
generating a set of possible solutions to the disruption;
calculating a cascaded cost for individual possible solutions; and
selecting a solution to the disruption based on the cascaded cost.

2. The method of claim 1 wherein disruptions are prioritized based on affect of the disruption on servicing the schedules.

3. The method of claim 1 and further comprising:
removing a disruption that has been solved from the list; and
repeating the elements of claim 1 for the items remaining in the list.

4. The method of claim 1 wherein calculating a cascaded cost comprises:
simulating servicing of the schedule; and
continuing the simulation to a selected level of cascading effects.

5. The method of claim 1 wherein the related schedules comprise schedules of the resources.

6. The method of claim 1 wherein the schedules are determined by finding patterns in resource utilization and resource assignment.

7. The method of claim 1 wherein prioritizing disruptions is based on the impact such disruptions have if left unattended.

8. A method of handling disruptions to a plurality of related schedules, the method comprising:
generating a set of possible solutions to a selected disruption;
calculating a cascaded cost for individual possible solutions; and
selecting a solution to the disruption based on the cascaded cost.

9. The method of claim 8 wherein calculating a cascaded cost comprises:
simulating servicing of the schedule; and
continuing the simulation to a selected level of cascading effects.

10. The method of claim 8 wherein the related schedules comprise the schedules of any resources in the timed activity.

11. The method of claim 8 wherein the schedules are determined by finding patterns in resource utilization and assigning resources to the schedules.

12. The method of claim 8 wherein colored Petri Nets are utilized to calculate cascaded costs for the possible solutions.

13. The method of claim 8 wherein costs are based on selected time frames for resources involved in the solutions.

14. The method of claim 13 wherein the time frames correspond to delay windows

15. A method of handling disruptions to a plurality of related schedules used by any resource in a timed activity, the method comprising:
receiving information describing disruptions;
prioritizing the disruptions in a list by simulating the effects of the disruptions if left unattended;
for the highest priority disruption in the list:
generating a set of possible solutions to the disruption;
calculating a cascaded cost for individual possible solutions; and
selecting a solution to the disruption based on the cascaded cost.

16. The method of handling disruptions of claim 15 wherein disruptions are selected from a group consisting of limitations, restrictions, and problems related to the resources.

17. The method of handling disruptions of claim 15 wherein solutions are selected from the group consisting of diverting/skipping, canceling, delaying, postponing maintenance checks, swapping with a spare or any such activity that would bring the system back to its state of normalcy.

18. The method of claim 15 wherein costs are selected from the group consisting of costs related to the operator availability.

19. The method of claim 15 wherein a cost of a resource delay disruption if left unattended is determined by:
determining the total delay of remaining resources in pattern and multiplying by a cost function.

20. A method of creating options for handling disruptions to a plurality of related schedules, the method comprising:
receiving resource disruption information;
identifying compatible resources to the disrupted resource;
determining availability on the compatible resources;
performing checks on the compatible resources; and
providing the list of compatible resources to a cost function for determining the cascaded cost of each compatible resource.

21. A method of handling disruptions to a plurality of related schedules being serviced by aircraft of an airline, the method comprising:
receiving information about a disruption to a schedule;
determining a time window based on expected arrival time and ground time;
identifying flights within the window;
determining an array of compatible flights from the identified flights;
determining the cascaded cost of the compatible flights; and
combining the compatible flights and cascaded costs for use in deciding whether or not to use a compatible flight.

22. A computer readable medium having instructions for causing a computer to perform a method of handling disruptions to a plurality of related schedules, the method comprising:
prioritizing the disruptions in a list;
for the highest priority disruption in the list:
generate a set of possible solutions to the disruption;
calculate a cascaded cost for individual possible solutions; and
selecting a solution to the disruption based on the cascaded cost.

23. The computer readable medium of claim 22 wherein disruptions are prioritized based on affect of the disruption on servicing the schedules.

24. The computer readable medium of claim 22 wherein the method further comprises:
removing a disruption that has been solved from the list; and
repeating the elements of claim 1 for the items remaining in the list.

25. The computer readable medium of claim 22 wherein calculating a cascaded cost comprises:
simulating servicing of the schedule; and
continuing the simulation to a selected level of cascading effects.

26. A computer readable medium having instructions for causing a computer to perform a method of handling disruptions to a plurality of related schedules, the method comprising:
generating a set of possible solutions to a selected disruption;
calculating a cascaded cost for individual possible solutions; and
selecting a solution to the disruption based on the cascaded cost.

27. The computer readable medium of claim 26 wherein calculating a cascaded cost comprises:
simulating servicing of the schedule; and
continuing the simulation to a selected level of cascading effects.

28. A computer readable medium having instructions for causing a computer to perform a method of handling disruptions to a plurality of related schedules used by an airline, the method comprising:
receiving information describing disruptions;
prioritizing the disruptions in a list by simulating the effects of the disruptions if left unattended;
for the highest priority disruption in the list:
generating a set of possible solutions to the disruption;
calculating a cascaded cost for individual possible solutions; and
selecting a solution to the disruption based on the cascaded cost.

29. A computer readable medium having instructions for causing a computer to perform a method of creating options for handling disruptions to a plurality of related schedules, the method comprising:
receiving resource disruption information;
identifying compatible resources to the disrupted resource;
determining availability of the compatible resources;
performing checks on the compatible resources; and
providing the list of compatible resources to a cost function for determining the cascaded cost of each compatible resource.

30. A computer readable medium having instructions for causing a computer to perform a method of handling disruptions to a plurality of related schedules being serviced by aircraft of an airline, the method comprising:
receiving information about a disruption to a schedule;
determining a time window based on expected arrival time and ground time;
identifying flights within the window;
determining an array of compatible flights from the identified flights;
determining the cascaded cost of the compatible flights; and combining the compatible flights and cascaded costs for use in deciding whether or not to use a compatible flight.

31. A system for handling disruptions to a plurality of related schedules, the method comprising:
means for prioritizing the disruptions in a list;
for the highest priority disruption in the list:
means for generating a set of possible solutions to the disruption;
means for calculating a cascaded cost for individual possible solutions; and
means for selecting a solution to the disruption based on the cascaded cost.

32. The system of claim 31 wherein disruptions are prioritized based on affect of the disruption on servicing the schedules.

33. The system of claim 31 and further comprising:
means for removing a disruption that has been solved from the list; and
means for repeating the elements of claim 1 for the items remaining in the list.

34. The system of claim 31 wherein calculating a cascaded cost comprises:
means for simulating servicing of the schedule; and
means for continuing the simulation to a selected level of cascading effects.

35. The system of claim 31 wherein the related schedules comprise airline schedules.

36. The system of claim 31 wherein the schedules are determined by finding patterns in airline flights and assigning aircraft to the schedules.

37. The system of claim 31 wherein prioritizing disruptions is based on the impact such disruptions have if left unattended.

38. A system for handling disruptions to a plurality of related schedules, the system comprising:
means for generating a set of possible solutions to a selected disruption;
means for calculating a cascaded cost for individual possible solutions; and
means for selecting a solution to the disruption based on the cascaded cost.

39. The system of claim 38 wherein the means for calculating a cascaded cost comprises:
means for simulating servicing of the schedule; and
means for continuing the simulation to a selected level of cascading effects.

40. A system of handling disruptions to a plurality of related schedules used by an airline, the method comprising:
a module that receives information describing disruptions;
a module that prioritizes the disruptions in a list by simulating the effects of the disruptions if left unattended;
for the highest priority disruption in the list:
a module that generates a set of possible solutions to the disruption;
a module that calculates a cascaded cost for individual possible solutions; and
a module facilitating selection of a solution to the disruption based on the cascaded cost.

41. The system of claim 40 and further comprising:
determining the total delay of remaining flights in pattern and multiplying by a cost function;
computing the total delay of passengers and multiply by a cost function;
identifying passenger connections and multiplying a number of connected passengers with a cost function; and
a module that receives the amounts so calculated and determines the cost of a flight disruption if left unattended.

42. A system for handling disruptions to a plurality of related schedules, the method comprising:
a module that prioritizes the disruptions in a list;
for the highest priority disruption in the list:
a module that generates a set of possible solutions to the disruption;
a module that calculates a cascaded cost for individual possible solutions; and
a module that selects a solution to the disruption based on the cascaded cost.

43. The system of claim 42 wherein disruptions are prioritized based on affect of the disruption on servicing the schedules.

44. The system of claim 42 and further comprising:
a module that removes a disruption that has been solved from the list; and
a module that repeats the elements of claim 1 for the items remaining in the list.

45. The system of claim 42 wherein calculating a cascaded cost comprises:
a module that simulates servicing of the schedule; and
a module that continues the simulation to a selected level of cascading effects.

46. The system of claim 42 wherein the related schedules comprise airline schedules.

47. The system of claim 42 wherein the schedules are determined by finding patterns in airline flights and assigning aircraft to the schedules.

48. The system of claim 42 wherein the module that prioritizes disruptions is based on the impact such disruptions have if left unattended.

49. A system for handling disruptions to a plurality of related schedules, the system comprising:
a module that generates a set of possible solutions to a selected disruption;
a module that calculates a cascaded cost for individual possible solutions; and
a module that selects a solution to the disruption based on the cascaded cost.

50. A computer readable medium having a colored Petri Net for execution by a computer to perform a method of handling disruptions to a schedule, the Petri Net comprising:
multiple tokens having multiple data items representing resources used to service the schedule; and
multiple transitions for processing the data items to provide a solution to disruptions that is optimized based on cascading costs of the solution.

51. The computer readable medium of claim 50 and further comprising at least one token representative of a disruption.

52. The computer readable medium of claim 50 wherein the transitions provide multiple solutions.
